(19) United States
(12) Patent Application Publication
(10) Pub. No.: US 2006/0226616 A1
(43) Pub. Date: Oct. 12, 2006

(54) Adjustable foot well and wheel fender for a jogging stroller

(76) Inventors: Greg R. Durrin, Selah, WA (US); Joseph P. Delorme, Yakima, WA (US)

Correspondence Address: STRATTON BALLEW, 213 S 12TH AVE, YAKIMA, WA, 98902, US

(21) Appl. No.: 11/095,308

(22) Filed: Mar. 30, 2005

(51) Int. Cl. B62B 7/00

(52) U.S. Cl. 280/47.4

(57) ABSTRACT

A fender mounted device for use with a three-wheeled stroller. The fender mounted device includes a pair of foot-wells, each for receiving and protecting a foot of a passenger of the three-wheeled stroller, often referred to as a “jogging” style of stroller. The fender mounts over the single forward wheel of the three-wheeled stroller. The fender has a shield portion for shielding a portion of both sides of the forward wheel from the feet of the passenger riding in the stroller. A base plate, also on each side of the fender, attaches to the fender and the frame of the stroller. A foot-well attaches to each base plate at a foot-well attachment point. Each foot-well has a cavity for receiving one foot of the passenger of the stroller. The base plate can include a plurality of attachment points for an adjustable attachment of the foot-well to the base plate.

### TECHNICAL FIELD

The invention relates to a foot-well and wheel fender device, specifically adapted for use with a jogging style of three-wheeled stroller.

### BACKGROUND OF THE INVENTION

Three-wheeled, “jogging” styles of strollers include a forward wheel and an opposed pair of rearward wheels. This three-wheeled stroller configuration is often referred to as a jogging or racing style of stroller, because they are well suited to being pushed at greater speeds, and more stable, maneuverable at these greater speeds than conventional four-wheeled strollers or carriages. The wheels of the three-wheeled jogging stroller are typically larger in diameter than the conventional, four-wheeled strollers and carriages. For the typical three-wheeled stroller, its wheels are similar to conventional bicycle wheels, with a spoked tire. The spokes typically radiate from a hub to support a rotating rim and tire.

Instead of infants, a greater number of three-wheeled style of strollers are being used for older passengers with special needs, providing these older passengers with desired mobility, speed and ease of use that a conventional wheel chair is unable to provide. Especially for older passengers riding in the stroller, the spokes of the front wheel of a three-wheeled stroller can present a safety hazard. Typically, the passenger sits directly behind the leading, forward wheel of the three-wheeled stroller. For larger passengers, this requires one foot to be paced on each side of the forward wheel. Normally, this potential straddling of the forward wheel is not an issue with the typical passengers of three-wheeled strollers, especially with infant passengers. However, For passengers with longer legs, the spinning forward wheel of the three-wheeled stroller presents a hazard. Additionally, special needs passengers lacking sufficient motor control, may not be able to maintain the location of their legs and feet in a conventional stroller. If the feet or toes of the passenger inadvertently contact the spokes of the rotating wheel, an injury may result. Additionally, if the foot of the passenger falls away from the three-wheeled stroller, and hit by a passing obstacle, or scrapes on the ground surface, further injury to the passenger may result.

U.S. Pat. No. 5,421,597 discloses a convertible three-wheeled infant stroller with a fender attached to a “step plate.” This fender and step plate combination are not adjustable, and additionally fails to shield the feet of the passenger from the spoked portion of the wheel. As with all conventional fenders, this fender's purpose is to prevent water spray and associated debris from flinging off the spinning wheel at the passenger.

U.S. Design Pat. No. 379,333 shows a two-seat stroller, with a single-piece construction. The stroller includes a tub-like arrangement of two seats, and a fender for the forward wheel of the stroller, which is also integrated into the tub design. This design fails to teach how a single-seat stroller could better shield the feet of a passenger from potential hazards.

A three-wheeled stroller is needed that individually maintains each foot of the passenger in a safe position, held in place and well shielded from the spinning forward wheel. The present invention will be better understood by reference to the following detailed description taken in conjunction with the accompanying drawings.

### BRIEF DESCRIPTION OF DRAWINGS

FIG. 1 is a perspective view of a foot-well and wheel fender device, according to an embodiment of the invention;

FIG. 2 is an exploded perspective view of a a foot-well and wheel fender device, according to an embodiment of the invention;

FIG. 3 is a top view of a portion of a foot-well and wheel fender device, according to an embodiment of the invention;

FIG. 4 is a front view of a foot-well and wheel fender device, according to an embodiment of the invention;

FIG. 5 is a perspective view of a foot-well and wheel fender device specifically adapted for use with a jogging style of three-wheeled stroller, according to an embodiment of the invention; and

FIG. 6 is a side view of a foot-well and wheel fender device specifically adapted for use with a jogging style of three-wheeled stroller, according to an embodiment of the invention;

FIG. 7 is a perspective view of a foot-well and wheel fender device, according to an embodiment of the invention; and

FIG. 8 is a side view of a foot-well and wheel fender device, according to an embodiment of the invention.

### DETAILED DESCRIPTION OF SPECIFIC EMBODIMENTS

The invention provides a fender mounted device for use with a three-wheeled stroller. More specifically, the fender mounted device includes a foot-well for receiving and protecting a foot of a passenger of the three-wheeled stroller, to provide a supplemental and adjustable containment of the passenger's feet.

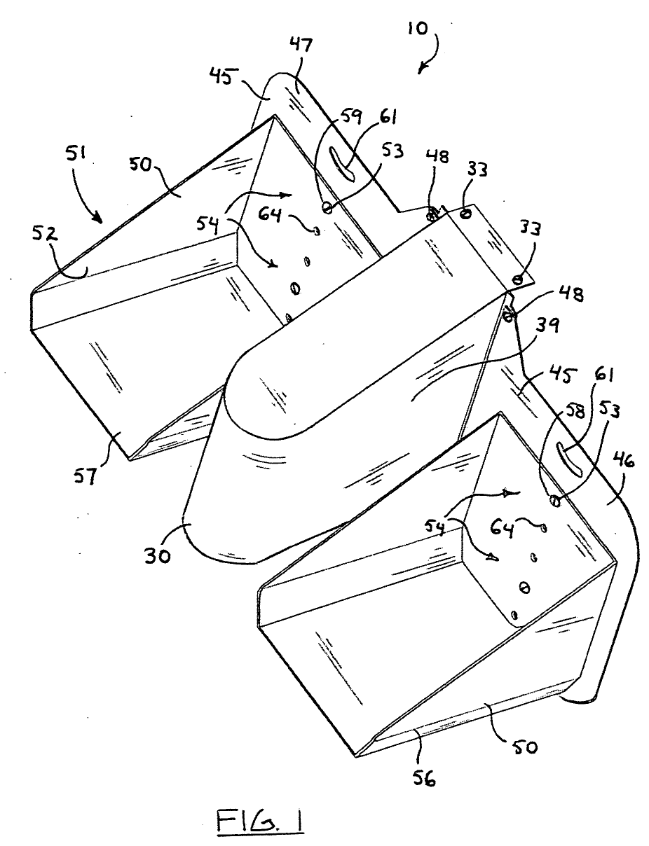

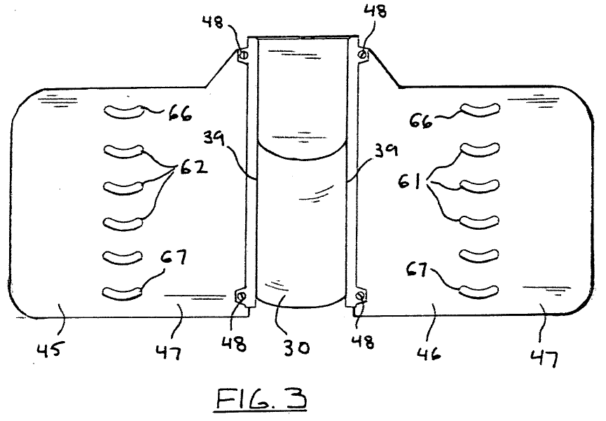

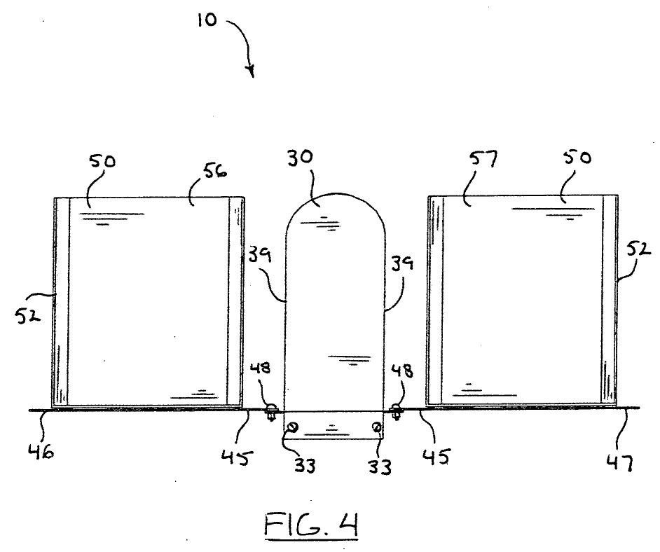

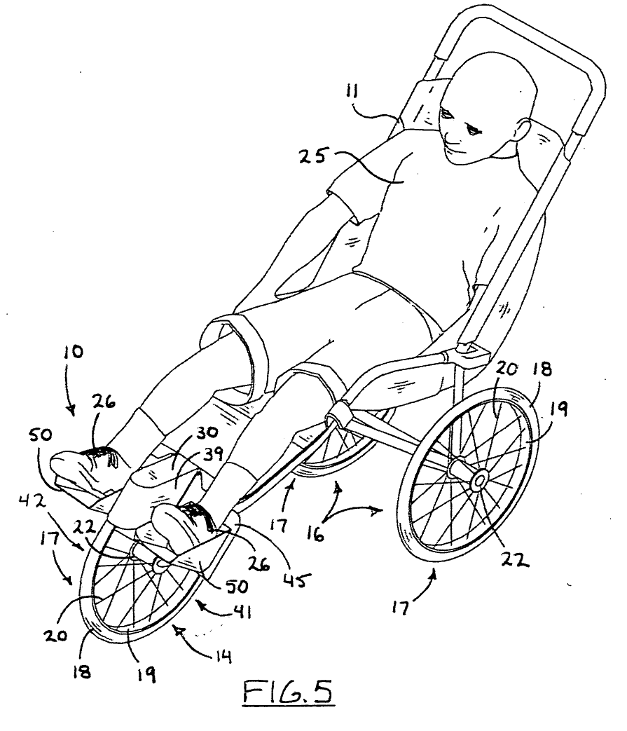

The fender mounted device 10 is shown in FIGS. 1 through 8. As detailed in FIG. 5, the three-wheeled stroller 11 includes a forward wheel 14 and an opposed pair of rearward wheels 16. This three-wheeled stroller configuration is often referred to as a “jogging” style of stroller. Wheels 17 of the jogging stroller are typically larger in diameter than conventional, four-wheeled “baby” strollers and carriages. The wheels of the typical three-wheeled stroller are similar to the conventional style of wheels typically used for bicycles, with each tire 18, most typically air inflated, supported by a rim 19. The rim typically includes spokes 20 that radiate from a hub 22 to support the rim.

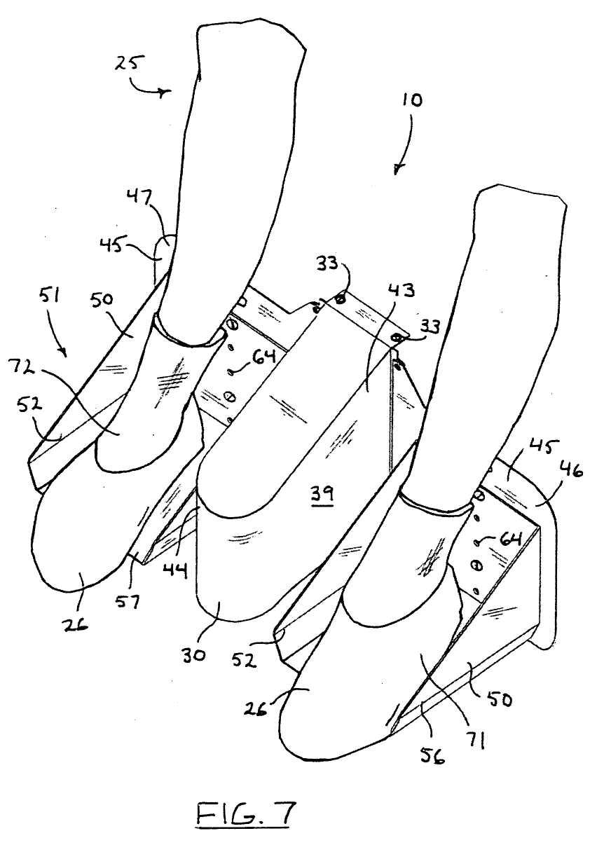

As discussed in the background section of the present disclosure, the spokes 20 can present a safety hazard to a passenger 25 riding in the three-wheeled stroller 11. Typically, the passenger straddles the leading, forward wheel 14 of the three-wheeled stroller, with a foot 26 on each side of the forward wheel, as shown in FIGS. 5 and 7. Contacting either the foot or toes of the passenger with the spokes of the spinning wheel, may result in injury to the passenger. Additionally, if the foot of the passenger falls away from the three-wheeled stroller, and hits a passing obstacle or scrapes on the ground surface, an injury to the passenger may also result. Therefore, a primary goal of the three-wheeled stroller fender mounted device 10 of the present invention, is to maintain each foot of the passenger in a safe position, held in place and well shielded from the spinning forward wheel.

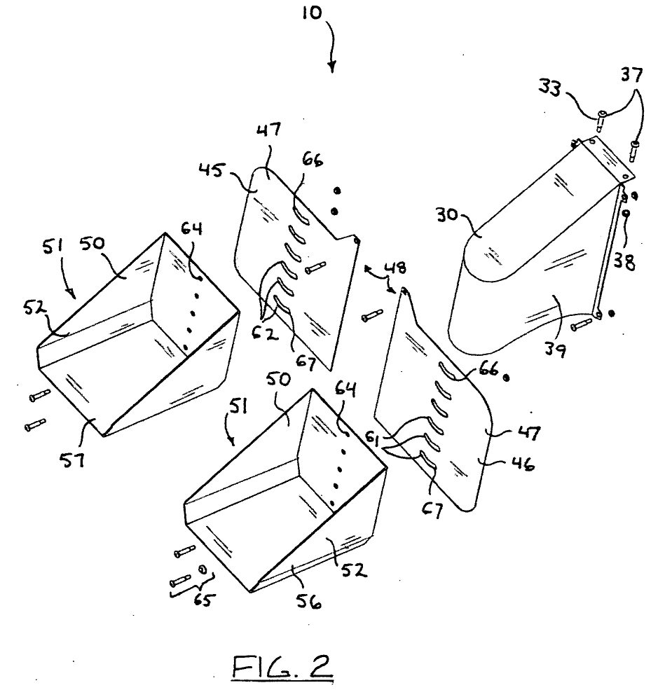

As detailed in FIG. 1, the fender mounted device 10 of the present invention includes a fender 30. The fender is preferably formed from a light metal or alternatively an impact resistant plastic material. A resin set fibrous material, such as a carbon or glass mat, are also considered as alternative to the most preferred metal material. The fender is preferably mounted to the three-wheeled stroller 11, and most preferably mounted to a frame member 32 of the three-wheeled stroller at a fender frame attachment 33. To mount the fender to the three-wheeled stroller, a fender screw 37 and a fender nut 38 are preferably used, as shown in FIG. 2. Multiple fender screws and fender nut pairs are preferred. However, as an alternative to the screw and nut, a U-bolt, strap, or some such attachment, as is well known to those skilled in the manufacture of thee-wheeled strollers could be used.

As shown in FIG. 5, the fender 30 includes a shield portion 39, which shields the foot 26 of the passenger 25 from the forward wheel of the three-wheeled stroller. The forward wheel is two-sided, namely including a first wheel side 41 and a second wheel side 42, as shown in FIG. 5. To provide a barrier between the passenger and forward wheel, the shield portion of the fender preferably includes a first shield portion 43, which extends over a portion of the first wheel side, and a second shield portion 44, which extends over a portion of the second wheel side, as shown in FIG. 7.

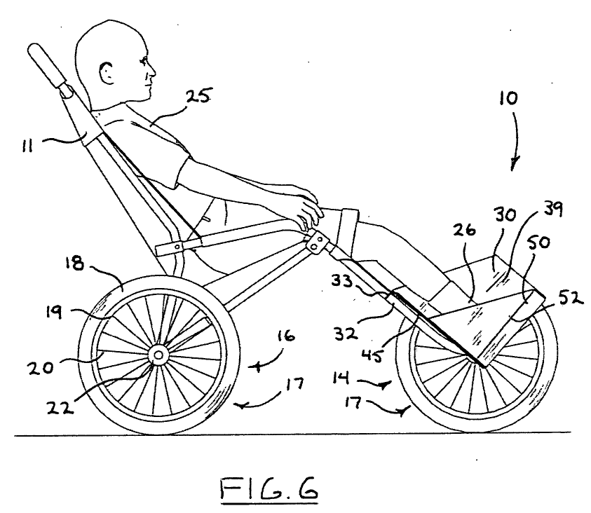

A base plate 45 abuts to and attaches to the fender 30, preferably with a plate fender attachment 48, as shown in FIGS. 1 through 4. This attachment of the base plate to the fender is most preferably a screw attachment, but may alternatively be a weld, adhesive, or any other type of attachment conventionally employed in this field of manufacture. The base plate preferably rests atop the frame member 32 of the three-wheeled stroller, as shown in FIG. 6. As with the fender, the base plate may amount to the frame member, or simply rest upon the frame, as preferred. However, this mounting may include, a weld, adhesive, or any other type of attachment conventionally employed in this field of manufacture.

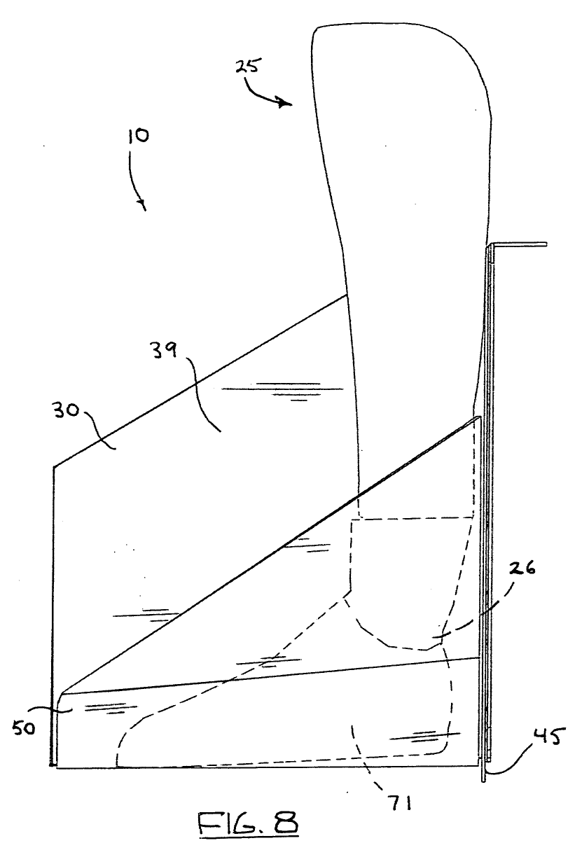

Along with the fender 30, the base plate 45 provides additional shielding to the passenger 25, and better protects the foot 26 of the passenger from the forward wheel 14, as detailed in FIGS. 7 and 8. The base plate is most preferably a flat sheet of metal material, thick enough to resist bending and denting, the metal material and thickness selectable by a person skilled in the manufacture of seating systems for three-wheeled strollers. Alternatively, the base plate may be an impact resistant plastic material, also as selectable by a person skilled in this field of manufacture. As with the fender, a resin set fibrous material, such as a carbon or glass mat, are also considered as alternative to the most preferred metal.

Most preferably, the base plate 45 is a first base plate 46 and a second base plate 47. The first base plate abuts to and attaches to the first shield portion 43 of the fender 30. The second base plate abuts to and attaches to the second shield portion 44 of the fender, as shown in FIGS. 1 and 2. Most preferably, the first base plate and the second base plate mounts to the fender and rest atop the frame member 32 of the three-wheeled stroller 11, as shown in FIG. 6.

A foot-well 50 mounts to the base plate 45, preferably as shown in FIGS. 1 and 2. The foot-well includes is a cavity 51, which is a scooped, partial enclosure formed by the foot-well. The cavity is sized and formed to receive the foot 26 of the passenger 25 of the three-wheeled stroller 11. The size of the cavity may vary, depending upon the level of constraint or enclosure desired for the foot of the passenger. Most preferably, as shown in FIGS. 5 through 8, the cavity is somewhat oversized, compared to a typical shoe size, to allow some movement of the foot. As detailed in FIGS. 1 and 7, the foot-well preferably includes an outer flange 52, to prevent the foot from slipping out of the cavity.

As discussed above, in regards to the materials preferred for the base plate 45 and the fender 30, the foot-well is preferably formed from a flat sheet of metal material that is thick enough to resist bending and denting. The material and thickness for the foot-well is selectable by a person skilled in the manufacture of seating systems for three-wheeled strollers. Again, a sheet or formed plastic, or a resin set fibrous material, such as a carbon or glass mat, are also considered as alternative to the most preferred metal material.

The foot-well 50 is attached to the base plate 45 at a foot-well attachment 53. Most preferably, as shown in FIGS. 1 and 2, the base plate has a plurality of foot-well attachment points 54. Each of the plurality of foot-well attachment points may be a slot, as preferred, or alternatively be a hole. As detailed in FIG. 2, the foot-well preferably includes a foot-well hole 64, for receiving a foot-well bolt set 65. The foot-well bolt set mounts the foot-well to the base plate. Most preferably, the foot-well bolt set is a pairing of a conventional nut and bolt or screw, and most preferably using a plastic cored “lock nut” for the nut. However, the foot-well bolt set may include any standard nut, wing nut, locking nut, knurled knob, or locking washer with nut. Alternatives to the preferred locking nut and bolt combination may be any attachment with a nut attached by a screw or bolt, attachable to the base plate at one of the plurality of foot-well attachment points. The bolt may be affixed directly to the base plate, or alternatively attached directly to the foot-well, in either instance with a welded, or similar acting connection.

As shown in FIGS. 1 and 2, the foot-well 50 of the fender mounted device 10, is preferably a first foot-well 56 and a second foot-well 57. Additionally, the foot-well attachment 53 may be a first foot-well attachment 58 and a second foot-well attachment 59. The first foot-well mounts to the first base plate 46 at the first foot-well attachment, and the second foot-well mounts to the second base plate 47 at the second foot-well attachment. As shown in FIG. 7, a first foot 71 of the passenger 25 is received and contained within the first foot-well, and a second foot 72 of the passenger is received and contained within the second foot-well.

Most preferably, the first base plate 46 has a first plurality of foot-well attachment points 61, and the second base plate 47 has a second plurality of foot-well attachment points 62. The first foot-well 56 is attachable to the first base plate at any one of the first plurality of foot-well attachment points. Likewise, the second foot-well 57 is attachable to the second base plate at one of the second plurality of foot-well attachment points. The particular foot-well attachment point selected for attachment of the foot-well is preferably determined as best suits the needs of the passenger, as shown in FIG. 5. For example, a passenger with shorter legs would need the foot-well attached to a rearward attachment point 66, and a passenger with longer legs would need the foot-well attached to a forward attachment point 67.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A fender mounted device for use with a three-wheeled stroller, the three wheeled stroller including a forward wheel and an opposed pair of rearward wheels, the fender mounted device comprising:
a fender mounted to the three wheeled stroller, the fender having a shield portion for shielding the forward wheel of the three-wheeled stroller;
a base plate attached to the fender, the base plate having a plurality of foot-well attachment points; and
a foot-well attachable to the base plate at one of the plurality of foot-well attachment points, the foot-well having a cavity for receiving a foot of a passenger of the three-wheeled stroller.

2. The fender mounted device of claim 1, wherein:
the shield portion of the fender is a first shield portion and a second shield portion;
the foot-well is a first foot-well and a second foot-well, the first foot-well includes a first cavity and the second foot-well includes a second cavity;
the foot of the passenger is a first foot and a second foot, the first foot receivable into the first cavity of the first foot-well and the second foot receivable into the second cavity of the second foot-well;
the base plate is a first base plate and a second base plate;
the first base plate attached to the first shield portion of the fender;
the second base plate attached to the second shield portion of the fender, and
the first foot-well attached to the first base plate, and
the second foot-well attached to the second base plate.

3. The of the claim 1, wherein the fender of the fender mounted device mounts to a frame member of the three-wheeled stroller.

4. An adjustable fender device for use with a three-wheeled stroller, the three wheeled stroller including a forward wheel and an opposed pair of rearward wheels, the adjustable fender device comprising:
a fender having a shield portion for shielding the forward wheel of the three-wheeled stroller, the shield portion of the fender including a first shield portion and a second shield portion;
a first base plate attached to the fender proximate to the first shield portion;
a second base plate attached to the fender proximate to the second shield portion;
the first base plate having a first plurality of foot-well attachment points;
the second base plate having a second plurality of foot-well attachment points;
a first foot-well attachable to the first base plate at one of the first plurality of foot-well attachment points, the first foot-well having a cavity for receiving a first foot of a passenger of the three wheeled stroller; and
a second foot-well attachable to the second base plate at one of the second plurality of foot-well attachment points, the second foot-well having a cavity for receiving a second foot of a passenger of the three wheeled stroller.

5. The of the claim 4, wherein the fender of the adjustable fender device mounts to the three-wheeled stroller.

6. A fender device for use with a jogging style of three-wheeled stroller, the three wheeled stroller including a forward wheel and an opposed pair of rearward wheels, the adjustable fender device comprising:
a fender having a shield portion for shielding the forward wheel of the three-wheeled stroller from a passenger of the three-wheeled stroller;
a base plate attached to the fender, the base plate having a plurality of foot-well attachment points; and
a foot-well attached to the base plate at a foot-well attachment, the foot-well having a cavity for receiving a foot of the passenger of the three wheeled stroller.

7. The fender device of the claim 6, wherein:
the shield portion of the fender is a first shield portion and a second shield portion;
the foot-well is a first foot-well and a second foot-well, the first foot-well and second foot-well each having the cavity for receiving the foot of a passenger of the three wheeled stroller;
the base plate is a first base plate and a second base plate;
the first base plate attachable to the first shield of the fender; and
the first foot-well attachable to the first base plate, and
the second foot-well attachable to the second base plate.

8. The fender device of the claim 7, wherein:
the foot of a passenger of the three wheeled stroller is a first foot and a second foot; and
the first foot receivable into the cavity of the first foot-well, and the second foot receivable into the cavity of the second foot-well.

9. The fender device of the claim 6, wherein the fender of the adjustable fender device attaches to the three-wheeled stroller.

10. The fender device of the claim 9, wherein the attachment of the adjustable fender device to the three-wheeled stroller includes a mount to a frame member of the three-wheeled stroller.
